(19) United States
(12) Patent Application Publication
(10) Pub. No.: US 2022/0256778 A1
(43) Pub. Date: Aug. 18, 2022

(54) SYSTEM AND METHOD FOR PORTABLE SELF-CONTAINED GREENHOUSE

(71) Applicant: Carlos T. Santiago, Oceanside, CA (US)

(72) Inventor: Carlos T. Santiago, Oceanside, CA (US)

(21) Appl. No.: 17/175,505

(22) Filed: Feb. 12, 2021

(51) Int. Cl. A01G 9/16; A01G 31/02; A01G 9/24; A01G 9/18; A01G 7/04; A01G 9/22; A01G 9/26

(52) U.S. Cl. CPC A01G 9/16; A01G 31/02; A01G 9/246; A01G 9/247; A01G 9/243; A01G 7/045; A01G 9/227; A01G 9/241; A01G 9/26; A01G 9/18

(57) ABSTRACT

The invention provides an improved system and method for a self-contained portable greenhouse, comprising a sun-light deprivation curtain system, and with a structural arrangement that integrates the fluid (liquid and air) distribution and dispensing for such plant life-support systems as water supply and irrigation, hydroponics water, nutrient and aeration, CO2 dosing, fuel (for power generation), forced-air ventilation, whereby its associated system components are miniaturized to a scale amenable for low voltage direct-current power, which are housed within the structure. The invention also provides a system architecture wherein the electrical interface infrastructure for connecting with electricity-producing resources—such as solar panels or wind turbines—is integrated into the portable greenhouse, as is the internal electrical distribution and direct-digital control for the plant life-support systems. The invention allows for multiple portable greenhouses to be interconnected along with other distribution energy resources (DER) in a DC microgrid arrangement.

### CROSS REFERENCE TO RELATED APPLICATIONS

This application is U.S. Non-Provisional Application which claims priority to U.S. Provisional Application No. 62/947,536 filed Dec. 12, 2019.

### FIELD OF DISCLOSURE

The field of disclosure is generally directed to controlled environment agriculture (CEA) and distributed energy resources (DER) and more particularly modular, environmentally controlled self-contained greenhouse growing systems for plants capable of operating remotely situated and in coordination when interconnected in a power, communications and thermal storage network.

### BACKGROUND

Plants are an essential part of life on Earth. Plants supply food to nearly all other terrestrial organisms, including humans and animals, some of which serve human consumption, and all of which cannot manufacture their own metabolic energy like plants. Plants absorb gaseous pollutants, like ozone, nitrogen oxides and sulphur dioxides, through their leaves when up-taking carbon dioxide for photosynthesis. Plants collect dust, ash, pollen and other particulate matter on their leaves and thus reduce these pollutants in the air. Plants have also been shown to reduce stress and provide beneficial health effects such as lowering blood pressure and releasing muscle tension.

Plant growth can be difficult in some areas because of climate, temperature, or topography. Greenhouses have been made to circumvent this and facilitate plant growth and are designed to shield plants from excess cold or heat and unwanted pests. Greenhouses provide gardeners with a way to provide a warm, humid environment for plants expanding gardening into the fall and winter, where the plant would otherwise not be able to survive un-housed. Greenhouses are typically enclosed structures and are made of materials such as glass. Greenhouses make it possible to grow certain types of plants year round, including fruits, tobacco plants, vegetables, and flowers. However, greenhouses require a significant amount of power such that they are typically limited to developed properties with an electrical service, particularly in inhospitable climates and/or seasons. Although the primary purpose of a greenhouse is geared towards plant growth, they are most commonly designed and built to house its human tenders, and as such must adhere to applicable building codes aimed at human safety, adding to the complexity and cost of what is otherwise a structure intended for plant-occupancy.

Various forms of smaller structures are presently available for use in homes, offices, and other such surroundings. These structures are employed to facilitate the growing of plants and for seed germination prior to planting in an outdoor garden. These structures still lack overall structural and mechanical arrangement such that it can be deployed in remotely situated ‘off grid’ sites, do not provide for the various components needed for plant growth including water-efficient plant growth systems, sunlight, carbon dioxide, heating and ventilation, are not easily manufactured or not complex to provide for versatility in different climates with varying available power sources, are not easily scalable, and are not amenable to the automation and robotization of its operation, instead relying (predominantly) on the constant attention and fairly manual operation of the user.

Thus, there still exists a need for a self-contained portable greenhouse that provides efficient and adjustable access to the confines of the plants growing chamber and associated plant-growth systems while providing automation for the various needs of plant growth for a variety of crops, at a scale of system components which creates conditions for a highly efficient remote and off the grid deployment in a variety of climates, powered by a variety of power sources, whereby it can be employed in a number of modular configurations.

### SUMMARY

It is therefore the object of the present invention to create a self-contained plant grow pod system, the system having a plant growing chamber which is accessed by an openable top which serves as the translucent roof of the grow pod and allows sunlight to enter the plant growing chamber. The plant growing chamber and top are supported by the structural support frame which supports accessible modules for power systems, including primary power interface and internal power distribution as well as direct digital control and monitoring system control components, which are attached to the exterior of the grow pod, and also houses—underneath the plant growing chamber—various plant life-support mechanical and electrical systems including: systems for plant-growth, such as deep-water culture hydroponics, aeration, irrigation and CO2 dosing; systems for environmental control of grow chamber, such as forced-air ventilation employing an evaporative cooling coil, water fogging system, hydronic heating system and thermal storage; and power systems, including internal power distribution, energy storage, as well as on-board power-generation and associated fuel system. The invention comprises a sunlight-deprivation system which is controlled by the control system and configured to roll a curtain onto the pod structure, the light deprivation system including a spring-loaded spool with two torsional springs located at ends and within the spool, the spool be driven by two arms located at ends of the pod structure whereby the torsional springs are attached to the arms opposite of the spool to ensure that the curtain is rolled taunt against the top of the pod structure, the arms driven by a rotating drive shaft. The rotating drive shift driven by a right-angle gear drive, whereby a motor is used to drive the right-angle gear drive, further including latching mechanisms positioned at the arms whereby the latching mechanism is configured to secure the spool in position and prevent any movement not initiated by the rotating drive shaft. The plant life-support electrical system comprises an integrated battery energy storage system whereby the power system powers the DC loads and charges batteries during normal daytime operation such that the batteries power the DC loads at night, the power system further including a backup charger, the backup charger a fuel-fired, engine driven electric charger, whereby the backup charger is comprised of piping, a fuel tank reservoir, a pod fuel dispenser, and a generator whereby the backup charger is positioned inside an acoustically lined, thermally insulated, and fire resistant enclosure within the pod structure, the power system configured to provide power sharing between a plurality of self-powered plant grow pod systems, whereby a set of loop-feed connections to a DC BUS are configured to permit self-powered plant grow pod systems to be interconnected in a daisy-chain arrangement to form a microgrid. The plant life-support mechanical system comprises a forced-air ventilation system wherein an evaporative cooler (swamp cooler) and a relief fan work in sequence to circulate air in the grow chamber via supply air and return air ducting which is integrated into the grow-pod structure in order to cool the grow chamber during excessively hot temperatures. The plant-growth system comprises a hydroponic system which is fashioned as a deep water culture method of plant production whereby the hydroponic circulation system pumps hydroponic water from an integral hydroponics reservoir into hydroponics grow buckets, whereby air blowers provide aeration within the grow buckets via an air bubbler, whereby a nutrient storage tank is periodically re-filled via a dispenser connection, and a nutrient feed pump system pumps from the nutrient tank, all of which is controlled by the control system via tank-float level sensors, water chemistry sensors and temperature. The plant-growth system comprises a chilled water system whereby a water chiller, a chilled water pump, a heat exchangers work in sequence to circulate chilled water to maintain desired temperature in the hydroponic reservoir and for chilled water thermal storage. The plant life-support mechanical system comprises a heating system which heats the grow chamber and hydroponic water reservoir during cold weather, the heating system including a zone control valve, radiant tubing, hydronic pumps, and associated valves and control devices, whereby hot water pumps circulate hot water thru a heat exchanger to maintain desired temperature in the hydroponic reservoir and for hot water thermal storage. Heating of the crops may be accomplished via radiant tubbing, which is looped around the hydroponic containers, whereby heat radiates directly to the plants in the hydroponic containers and to the grow chamber, the system being configured to interface with an external primary hot water heating source such as solar water heater. The structure is arranged such that a system distribution manifold runs the length of the grow pod, providing various connection points for various plant-growth systems, a means of re-filling integral tanks for such things as nutrient water and fuel, as well as a dispersion point for heating and or cooling air and water for environmental control of plant grow chamber, and a structural arrangement wherein a means of forced air ventilation is integral to the grow pod. The system is configured to be connected to one or more of a power plant, a heating plant, or an external water supply.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a perspective drawing that illustrates the exterior of the grow pod according to an illustrative embodiment.

FIG. 2 is a perspective drawing that illustrates the pod structure and base frame according to an illustrative embodiment.

FIG. 3 is a plan view that illustrates the top of the grow pod, along with references to section and elevation views according to an illustrative embodiment.

FIG. 4 is an elevation view that illustrates the side of the grow pod according to an illustrative embodiment.

FIG. 5 is an elevation view that illustrates the end view of the grow pod according to an illustrative embodiment.

FIG. 6 is a traverse section view illustrates the grow pod structure and plant life support system according to an illustrative embodiment.

FIG. 7 is a traverse section view illustrates along a different location of the grow pod structure and plant life support system according to an illustrative embodiment.

FIG. 8 is a traverse section view illustrates along a different location of the grow pod structure and plant life support system according to an illustrative embodiment.

FIG. 9 is a plan view that illustrates how the various life-support system components are arranged within the grow pod structure, along with references to section and elevation views according to an illustrative embodiment.

FIG. 10 is a plan view along a different level of the grow pod that illustrates how the various life-support system components are arranged within the grow pod structure, along with references to sections according to an illustrative embodiment.

FIG. 11 is a plan view along a different level of the grow pod that illustrates how the hydroponics nutrient circulation system is arranged within the grow pod structure, along with references to sections according to an illustrative embodiment.

FIG. 12 is a piping diagram that illustrates the hydroponics circulation system according to an illustrative embodiment.

FIG. 13 is a piping diagram that illustrates the hydroponics aeration system according to an illustrative embodiment.

FIG. 14 is a piping diagram that illustrates the hydronic heating system according to an illustrative embodiment.

FIG. 15 is a piping diagram that illustrates the hydroponics nutrient system according to an illustrative embodiment.

FIG. 16 is a piping diagram that illustrates the hydroponics aeration system according to an illustrative embodiment.

FIG. 17 is a piping diagram that illustrates the water chiller system according to an illustrative embodiment.

FIG. 18 is a wiring diagram that illustrates how the primary power, electrical distribution and control systems are arranged together according to an illustrative embodiment.

FIG. 19 is perspective drawing that illustrates interconnected grow pods along with heat and electricity-producing resources according to an illustrative embodiment.

FIG. 20 is site plan drawing that illustrates interconnected grow pods along with heat and electricity-producing resources according to an illustrative embodiment.

FIG. 21 and FIG. 22 are plan views that illustrates various possible embodiment of the plant life support environmental control system.

FIG. 23 is a traverse section view illustrates along a different location of the grow pod structure and plant life support system according to an illustrative embodiment.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined).

“Exemplary” is used herein to mean “serving as an example, instance, or illustration.” Any aspect described in this document as “exemplary” is not necessarily to be construed as preferred or advantageous over other aspects

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items,” may indicate the presence of only one item, or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description. Such well-known features include: direct-current (dc) bus battery storage and pv solar systems, which can be found in some off grid electrical systems, and can sometimes include safety shunts, fuses and dedicated controls; dc electrical distribution systems, which can be found in some automotive and yacht electrical systems, and include safety fuses and relays which can be switched by a controller; deep-water culture hydroponics circulating systems; direct-digital control systems, which comprise controller, control devices and sensors, and can sometimes be found in some building automation systems; compact water chillers, which comprise compressors, refrigerant expansion valves, evaporator, condenser, and can have an on-board controller; direct-current microgrid systems, which can be defined as power cluster of distributed generation, load, and energy storage device accumulated together in the vicinity to each other.

The present disclosure is generally drawn to a system and method, according to one or more exemplary embodiments, for a self-contained portable greenhouse, which, through the solar panels utilizing solar power systems convert solar energy into electrical energy, for the power supply system.

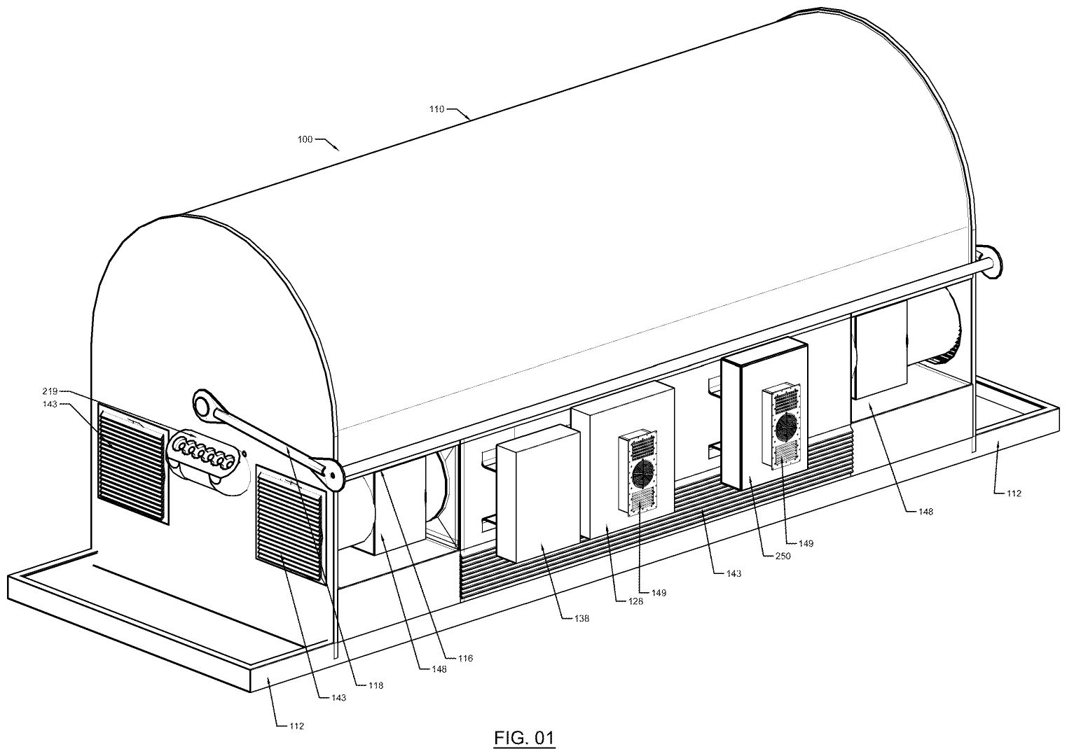

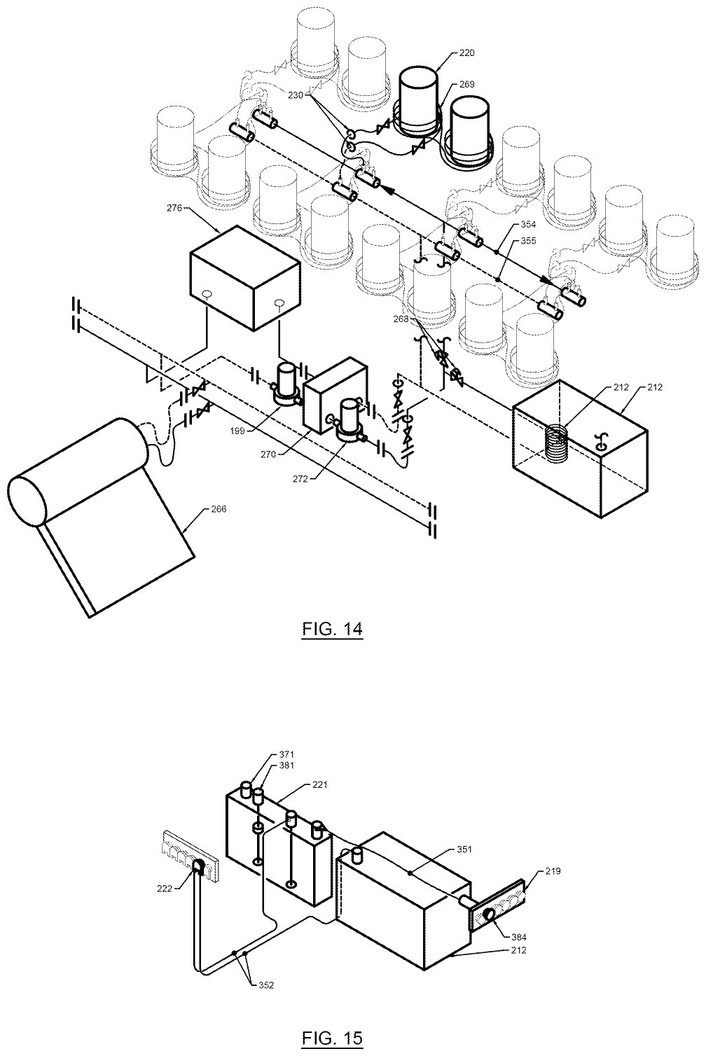

One exemplary embodiment described herein, describes a system that is an off-grid, self-powered plant grow pod, such as self-contained plant grow pod 100, as illustrated in FIG. 1 thru FIG. 11 and FIG. 14. The word grow pod is only for descriptive purposes and may be instead replaced with improved portable greenhouse or variation thereof. Grow pod 100 includes a greenhouse top, and integral electrical, mechanical, and plant growth systems. This system, in general terms, may include a top, a pod structure, a light deprivation mechanism, a plant life-support system, and some essential external infrastructure.

With reference to the specific features of the system, top 110 may generally be described as the roof of the growing chamber. Top 110 may be comprised of a translucent substrate and a support structure so that top 110 allows light into the interior of the growing chamber, and also forms a barrier between the vegetation and the exterior environment. The translucent substrate of top 110 may be fashioned from, but is not limited to, fiberglass, plexiglass, polycarbonate, or vinyl. One non-limiting embodiment of the top may consist of semi-transparent solar panels, integrated with glazing mullion system 349, which may be interfaced with primary module 128. The support structure of the top may be fashioned from, without limitation thereto, a PVC, wood or steel framing, or a self-supported translucent panels. The support structure may be shaped and sized according to the intended crop such that it does not stray away from the intent of the present invention.

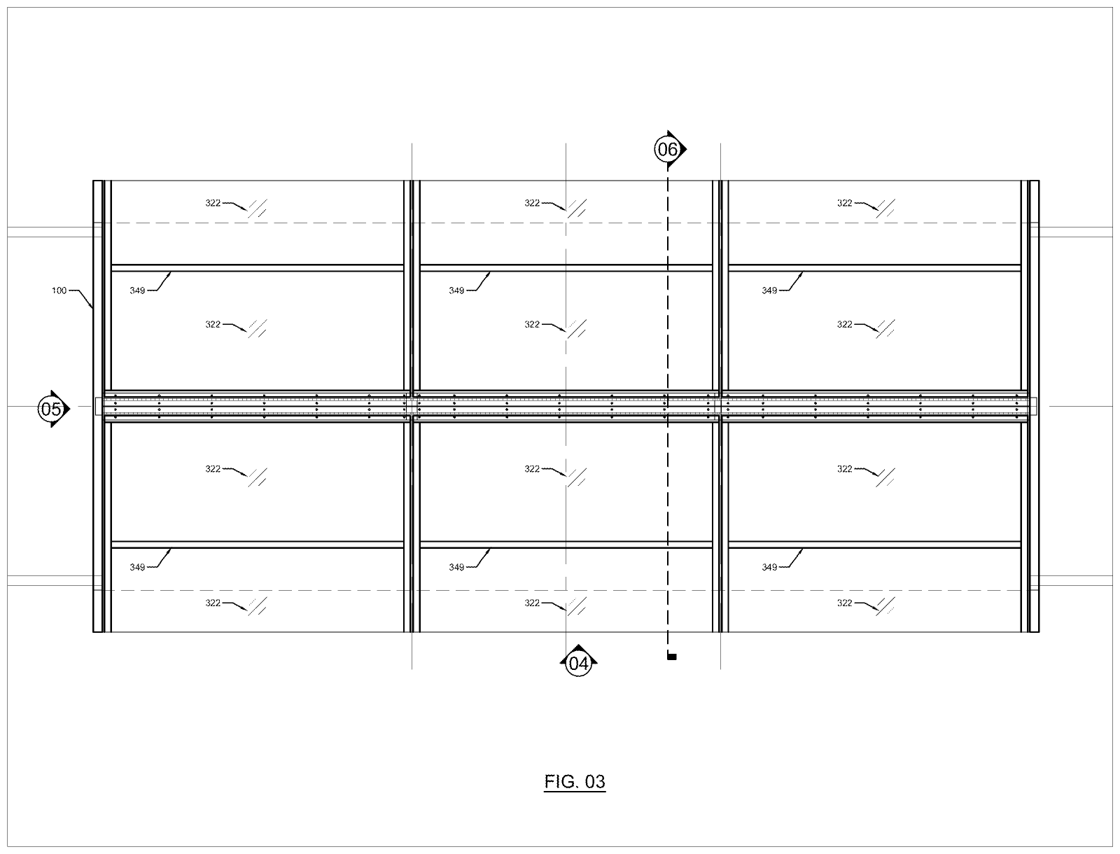

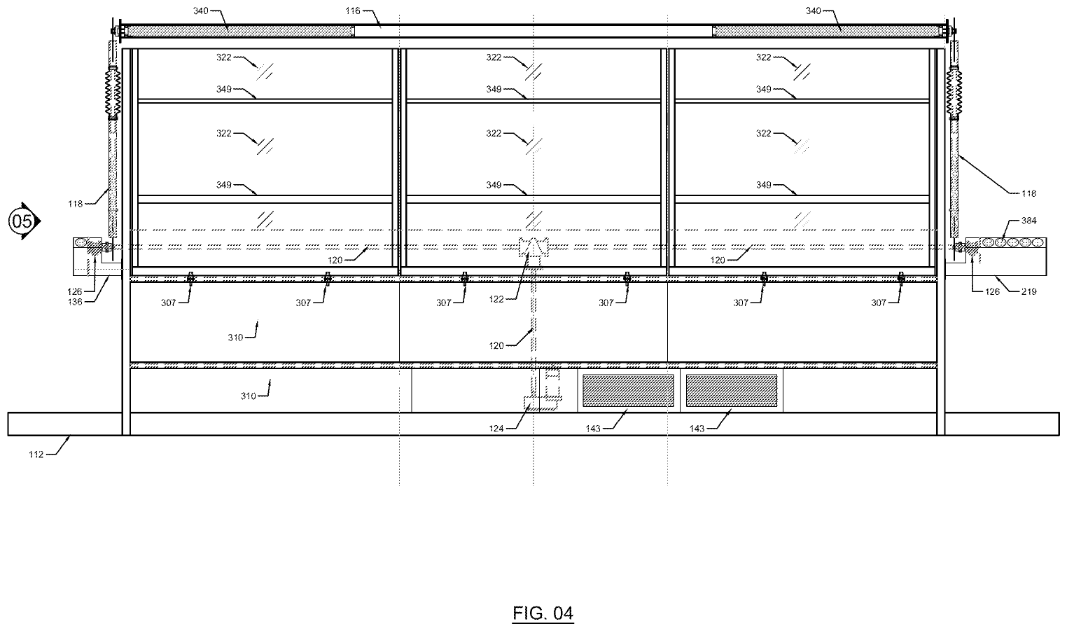

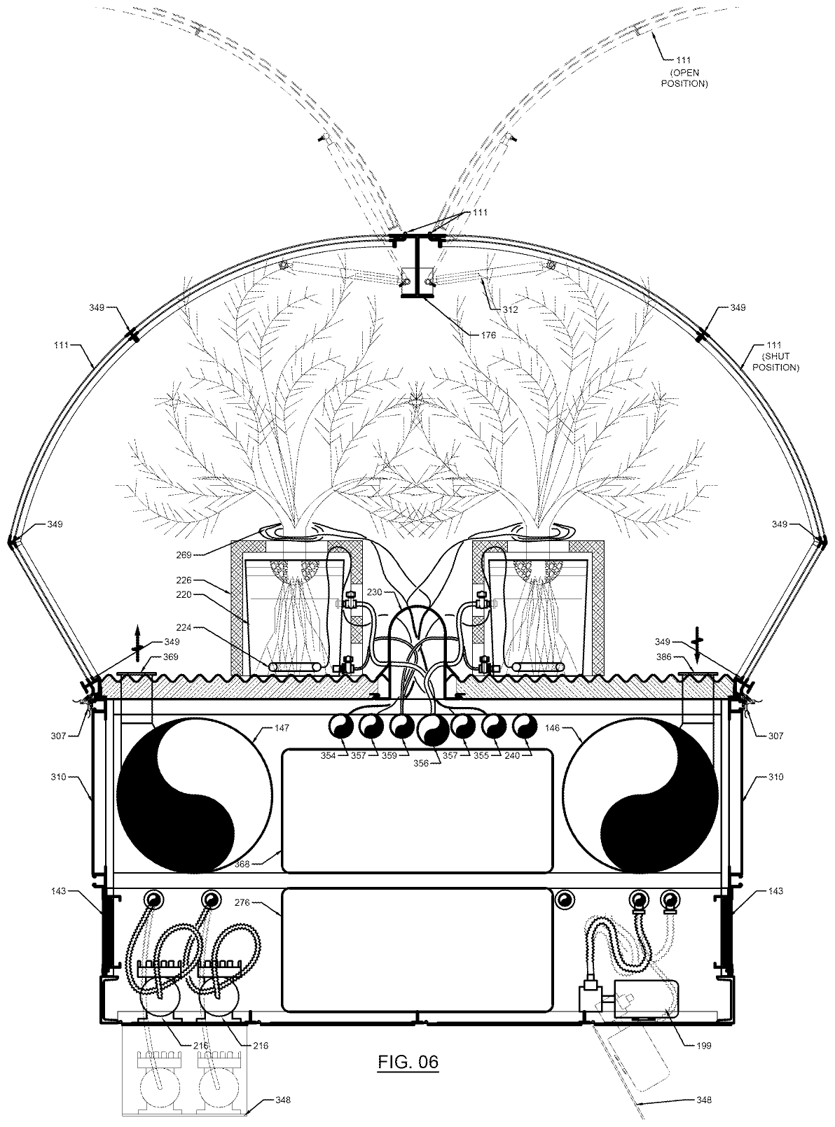

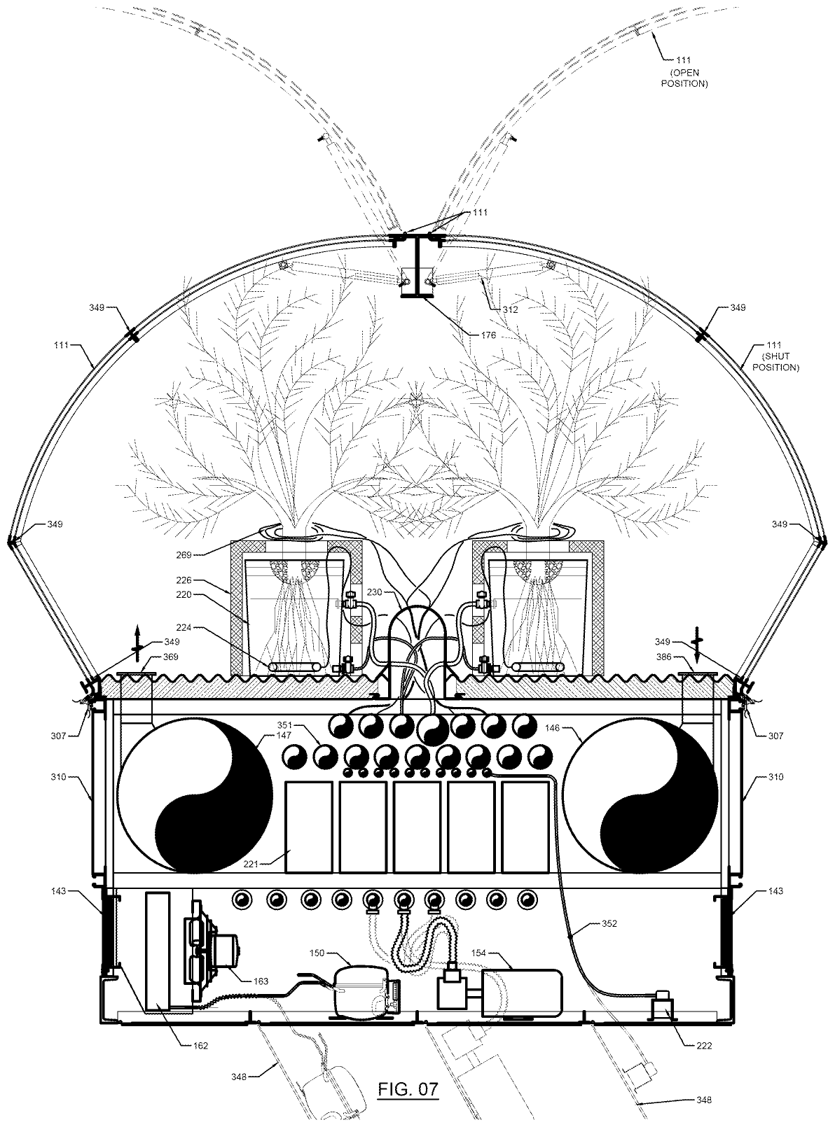

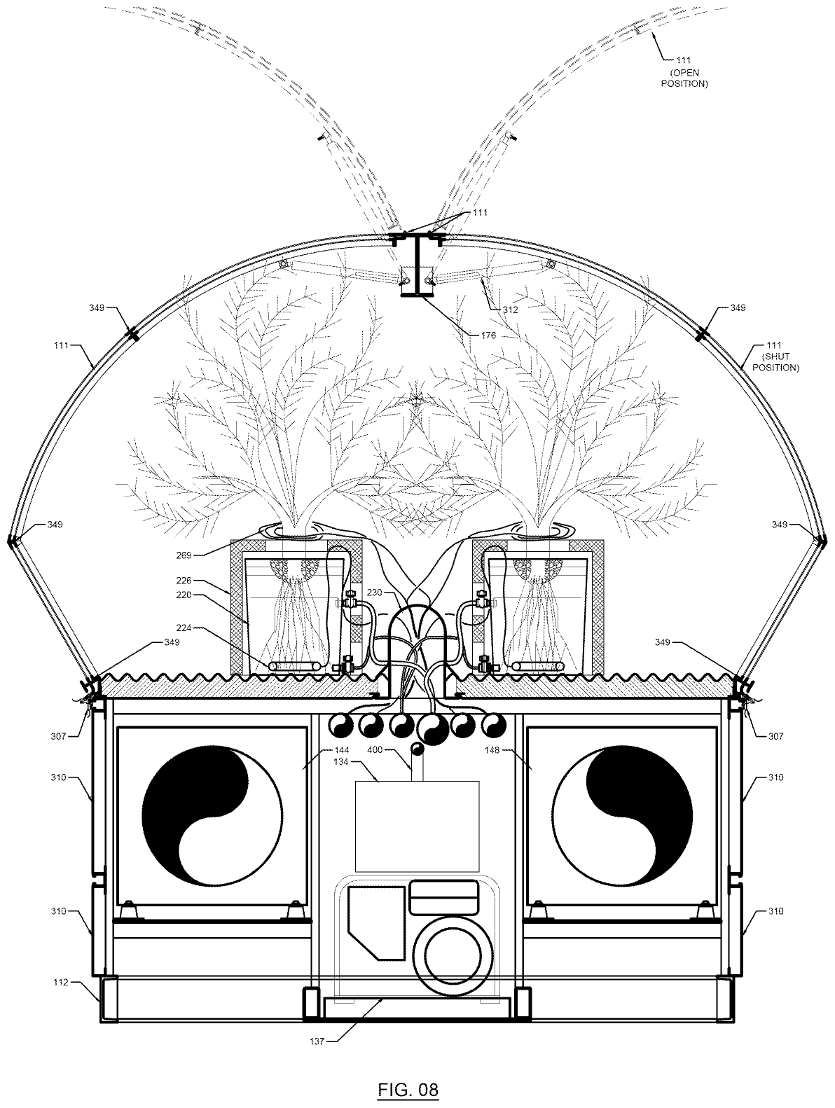

With reference to the top, it may be comprised of a polycarbonate panel 322 and steel glazing mullion 349 system, which is shown on FIG. 3, FIG. 4, and FIG. 6 thru FIG. 8. In this arrangement, a structural member 176 spans the length of the top and serves as a jamb for a dual hinged lid 111, as well as support for other plant life-support system components such as grow lights or plant-tending robotics. A gas-spring 312 may be used to aid in the operation of the lid. A tension-latch 307 may be used to keep the lid shut, and rubber gasketing may be used to ensure an air-tight grow environment.

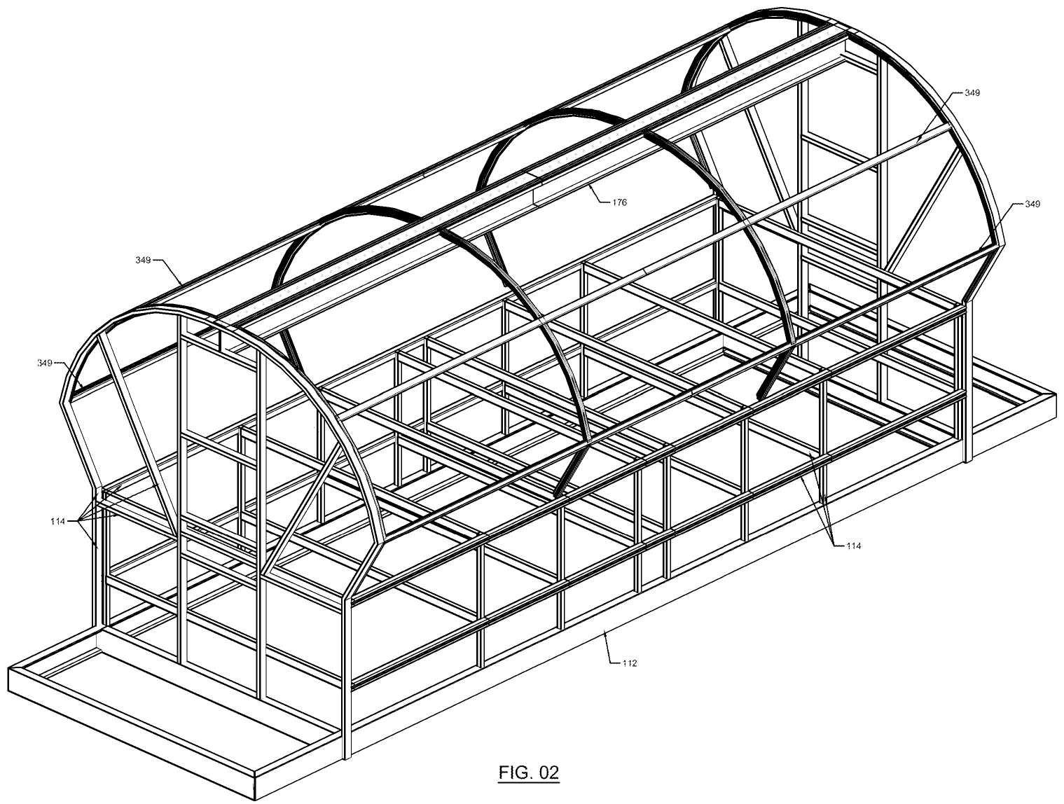

With reference to the pod structure, the grow pod 100 may be comprised of a structural base frame 112, a support frame 114, and cladding 310 as illustrated in FIG. 1 thru 11. The base frame 112 in FIG. 2 provides for a structurally rigid base as the means to set up the grow pods 100, provide a solid surface for the equipment to be mounted on, a spill containment means, and also facilitates the transportation of the structure. The base frame 112 may be fashioned as, a structural, C-Channel shape which may form the perimeter. Other variations in shape and size may also be used as well for the base frame 112 other than the C-Channel shape. The base frame 112 may also include a sheet as the floor and any other necessary structural stiffeners to provide a self-supported base which is designed to be able to withstand weight and vibrations from the equipment and also be capable of transportation once the grow pod 100 is fully assembled. In this non-limiting embodiment, the base frame 112 of the pod structure 100 may also have access panels 348 which would be placed in locations on the base frame to provide a means to access equipment placed within the grow pod 100, such as generators 137, pumps 154, 199, 218, 272, blowers 216, and other operable components. The base frame 112 may also have attachment means, which may include a crane hoist attachment and a quick-release attachment to a foundation system. The attachment types may include, but are not limited to, concrete footings or helical piles, and may be tailored to any foundation type.

Also, with reference to the pod structure, the support frame 114 in FIG. 3 provides a support structure which may be made of, without limitation, a steel structural frame. In this non-limiting embodiment, the support frame 114 is fashioned so as to provide support for a distribution system, integral liquid tanks, a light deprivation system, a deep water culture plant buckets 220, cladding, and other systems integral to the grow pod 100. The steel structural frame may be designed to be suitable for all types of weather or environmental changes, as well as comply with any seismic code requirements.

With reference to the pod structure, another included feature is the cladding. The cladding may be characterized as the covering of the grow pod 100. The cladding is provided to create a barrier against weather, environmental elements, and also acoustics between the plant life-support equipment and the external environment. Cladding may be made of material including, but not limited to, stainless steel, coated steel galvanized steel, and/or molded plastic or 3D plastic. The chosen material may be dependent on the environment where the grow pod 100 is intended to be used and the plant life utilized.

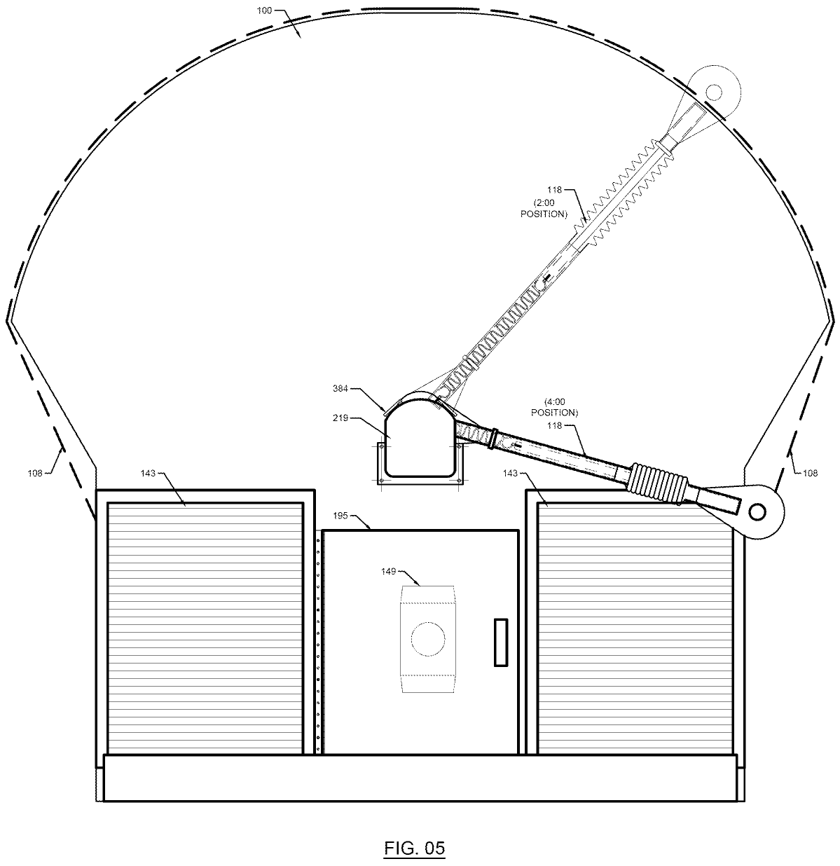

With reference to the light deprivation mechanism, a preferred non-limiting embodiment employs a roll-up style curtain. The light deprivation system configuration is fashioned based on the shape of grow pod top 110. The light deprivation curtain 108 may be rolled on to the grow pod 100 via a spring-loaded spool 116, as illustrated in FIG. 1 and FIG. 4 and FIG. 5. Two torsional springs 340 may be located at both ends and within the spool 116. The spool 116 may be driven by two arms 118, located at both ends of the grow pod 100. Each torsional spring 340 may be attached to the spool 116, and to the arm 118 on the opposite end of the torsional spring 340. This arrangement may ensure that the light deprivation curtain is rolled taunt against the grow pod top 110. In one non-limiting embodiment, the arms 118 may be driven by a rotating drive shaft 120. The shaft 120 may be a driven right-angle gear drive 122. The center of the gear drive 122 location may be based on the height and width of the grow pod 100. Gearmotor 124, which may be located within the grow pod 100, drives the right-angle gear drive 122. Latching mechanisms 126 may be located at both arms 118, which may secure the spool 116 in position and prevent any movement not initiated by the drive shaft 120. The light deprivation motor is controlled by the direct-digital control system. The light deprivation curtain 108 may consist of: a black-out curtain, which blocks out all sunlight; or a perforated or patterned sun-screen which may limit the amount of sunlight entering the growing chamber.

An exemplary embodiment of the plant-life support mechanical and electrical systems may include: systems for plant growth, such as hydroponics, irrigation and CO2 dosing; systems for environmental control of grow chamber, such as integral swamp cooler(s) and internal air distribution ducting, water fogging system, and hydronic heating system; power systems, including primary power interface, internal power distribution, direct-digital control system, as well as on-board power-generation and associated fuel system; and a sunlight-deprivation system. Alternate embodiments may include an irrigation and fertigation system in lieu of a hydroponics system, or the addition of an artificial grow lighting system to the environmental control system.

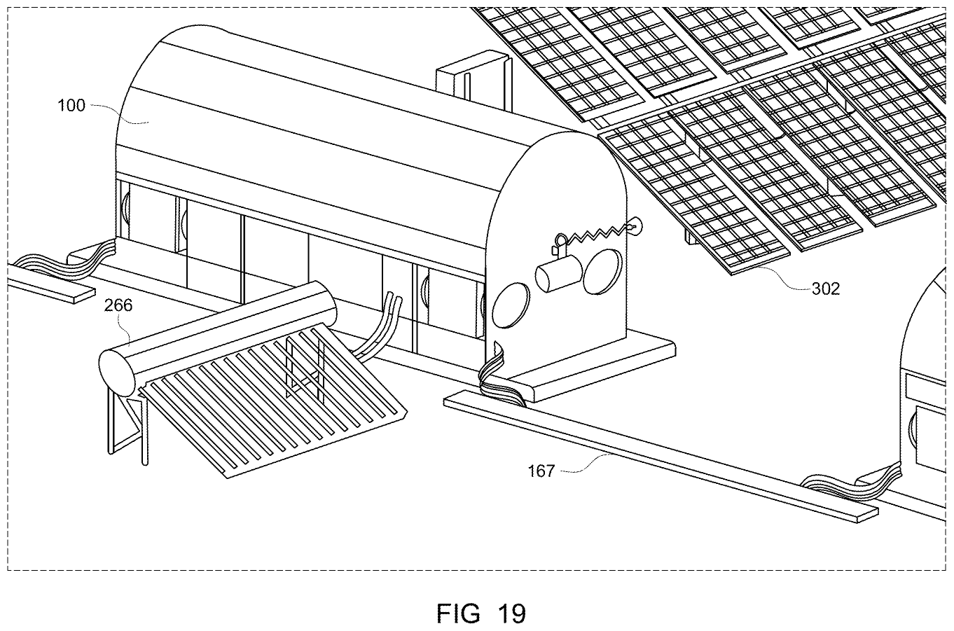

In one or more non-limiting embodiments, the plant-life support electrical system may consist of a 24 volt (V) direct current bus (DC BUS). The 24V DC BUS may be connected to a battery energy storage unit 132, diesel-fired DC charger 137, PV power plant, DC loads, without limitation thereto. The connections between the various primary power components may be via all necessary safety and control devices, such as fuses 140, disconnect switches 432, or circuit breakers. The electrical system may include several main hubs of wiring and control drives. One such hub may be a primary power module 128, which may be provided to interface with the primary power harvesting and distribution. Another hub may be a control module 250, provided to house the direct-digital control system components. Another main hub may be the power distribution module 138 (e.g. as shown in FIG. 1) which may house a switched/relayed and fused secondary power distribution block 210. The overall power distribution system may include a system of wires from the main source which terminate at the various modules, sensors, control devices, and equipment via connectors which may be industry standard weatherproof connectors. The connectors are intended to integrate power, i/o signal, and communication wiring into a single point connection. FIG. 19 illustrates wiring shielded by a utility trench box 167 as well as utility sharing tubing and conduit daisy-chaining.

Turning to FIG. 1, FIG. 1 shows an exemplary depiction of a primary power module, such as primary power module 128. The primary power module 128, may be housed in a weatherproof enclosure that may be connected to the 24V DC distribution system. A panel-mounted peltier cooler/heater 149 may also be included to protect sensitive electronic components in extreme climates. As illustrated also in FIG. 18, primary power module 128 may be a part of the electrical system, may include a DC system main on/off switch 438 controlled by a power monitoring device, a battery shunt-trip relay 437 controlled by a battery monitoring device, a photo voltaic (PV) charge controller 204, a battery array 132, a battery management system, a photo voltaic (PV) combiner panel 208, a primary power controller 202, which controls the various internal power module components, and facilitates the coordination of multiple grow pods connected by a microgrid, according to one or more non-limiting embodiments.

An energy storage system may also be included in the plant-life support electrical system. The energy storage system may be comprised of a lithium-ion battery array 132, as illustrated in FIG. 8 with an integrated battery management system (BMS), wherein the PV power system may power the DC loads and charge the batteries during normal daytime operation such that the batteries power the DC loads at night. Other battery arrays types may also be considered which include and are not limited to Absorbed Glass Matt (AGM) and Sealed Lead Acid (SLA). The battery array 132 may be located in a thermally insulated, temperature controlled compartment within the grow pod 100, accessed via battery compartment access door 195. The battery array 132 may be located separately from the rest of the equipment. In other non-limiting embodiments, the energy storage system may be comprised of a mechanical power storage system such as a compact DC flywheel.

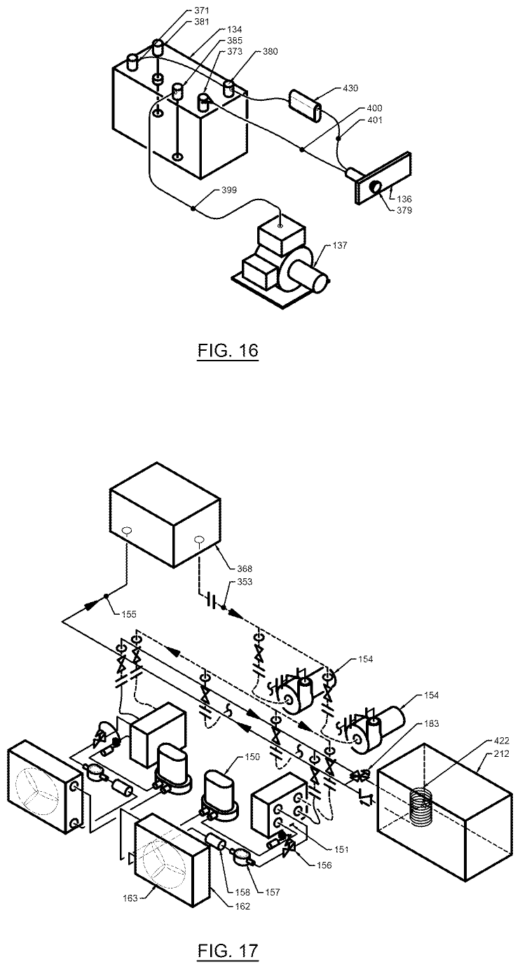

The electrical system may also include a backup charger 137. The backup charger may be a compact, fuel-fired, engine driven DC electric charger. As illustrated in FIG. 16, the fuel system of the backup charger may include: fuel fill piping 400 from pod fuel dispenser 136 via a fuel fill connection with integral fuel vent termination 379, to fuel tank 134 via a tank inlet control valve 373; a fuel tank vent system, which may include vent piping 401, a grade vent 371, a fill-limit vent valve 380, a fuel vent carbon-filter 430, in order to safely vent air displaced by fuel as levels fluctuate; and a fuel supply system which supplies fuel to generator 137 from fuel tank 134 via an anti-siphon valve 385 and fuel supply line 399. The fuel tank may have a level float sensor which may be tied-into the DDC system. The backup charger 137 is connected to the primary DC BUS via a DC to DC inverter 435 and a magnetically operated disconnect switch 436, which is controlled by power controller 202. The charger may have a specialized proprietary local controller 443 that may communicate with the primary power system via Modbus protocol. The backup charger may be used as back-up power in the event of a power outage or in the event the PV charge is insufficient due to cloudy days, and other events. The location of the backup charger may be in an acoustically lined, thermally insulated, and ventilated enclosure within the grow pod 100. The charger maybe be accessed via a louvered access door 143, on which a compartment ventilation fan 194 may be mounted to. Air for combustion is drawn from the louvered access door 143 and exhausted via muffler 397 to the grow pod exterior.

As illustrated in FIG. 18, a power distribution module 138 may also be a part of the plant life-support electrical system. The power distribution module 138 may include a fuse block 140, switched relays 139, terminals and seals, and waterproof connectors integrated into a power distribution block 210. The power distribution module 138 feeds the load side of the 24VDC bus. Each load circuit has a fuse 140 in order to provide overcurrent protection. Loads that require automatic remote control include a relay 139, which is switched on/off by the direct-digital control system.

The electrical system may also feature power sharing between several grow pods 100. A set of loop-feed connections 394 to the DC BUS may allow for grow pods 100 to be interconnected in a daisy-chain arrangement to form a DC microgrid. The power sharing features allows for a heterogeneous mix of grow pods 100 with different “options”, such as an arrangement where one grow pod with a charger may provide backup power to multiple other grow pods 100 without a charger of their own, in addition to the host grow pod 100. Combined with similar other energy generation options may enable the potential for a diverse suite of grow pods 100 for a more robust and reliable architecture.

In one or more non-limiting embodiments, the grow pod may be configured to behave as a distributed energy resource in a microgrid, providing capabilities such as: load shedding, whereby the plant life-support thermal storage system may be employed to defer electrical loads—such as equipment serving plant life-support cooling loads—to points in time that are optimum for the overall operation of the microgrid; providing energy storage via one or more embodiments of the plant life-support energy storage system; load charging capability via one or more embodiments of the plant life-support fuel-fired backup DC charger; load discharging, wherein the primary power module provides a controlled interface of electricity-producing resources such as solar PV's and wind turbines; and load sharing capabilities, wherein the primary power module on various grow pods work in sequence to connect the primary power DC bus and the various DC loads distributed amongst a cluster of grow pods; whereby each grow pod acts as a multi-function node with varying degrees of said capabilities. Plant life-support electrical loads are largely consistent day to day, thus providing for a predictable load profile. The resiliency of plants to fluctuations in environmental and nutrient conditions can also be estimated for any given crop, allowing for a controlled shedding of the electrical loads associated with plant chamber environmental control and plant life-support systems, wherein said load shedding can be staged such that each grow pod experiences only an intermittent loss of non-critical systems, thus adding to the stability of a DC microgrid made up of a network of grow pods.

In this non-limiting embodiment, grow pods may be connected by a primary power bus via power sharing connection 394, and powered by a solar array 302 and a wind turbine 288 as illustrated by FIG. 19. The PV array system 302 and associated combiner panel 208 are interfaced with grow pod 100 via primary power module 128, as illustrated by FIG. 18. The primary and secondary bus may be separated by a voltage transformer to facilitate a higher transmission primary DC voltage in large clusters.

A control module 250 may also be included in the plant life-support electrical system which may provide a for a single point of access and connection point for signal and sensor wiring connecting the various plant life-support devices within the grow pods, and commands from outside. In one non-limiting embodiment, direct-digital control (DDC) system may be a class of control system architecture used for the grow pod 100. DDC uses computers, networked data communications and graphical user interfaces (GUI) for the management of the various sensors, control devices and controllers. The DDC system may include a system controller 442 which may interface with the sensors and equipment and facilitates the aggregation of data for trending purposes. Such data may include but is not limited to water metering, electric power usage and generation metering, weather data, nutrient feed usage, equipment start/stop and error logging. The GUI may be customized for the grow pod 100. The DDC system also facilitates the video feed from IP camera(s) 448, which may be employed inside the plant growing chamber and/or deployed to monitor the exterior. In one non-limiting embodiment where multiple grow pods are connected to form a microgrid, system controller 442 and power controller 202 communicate to enable an implementation of the invention in which there may be numerous grow pods in various states of power and control modes.

This arrangement may provide a readily accessible means of monitoring multiple grow pods 100 through the web. The monitoring may be implemented through common controllers, sensors, and control devices. Sensors may include a plurality of detectors mounted or otherwise connected to control system. Sensors may have infrared (“IR”) detectors having photodiode and related amplification and detection circuitry to sense the presence of occurrences or events happening with the plant-life. In other embodiments, radio frequencies, magnetic fields, and ultrasonic sensors, temperature sensors, pressure sensors, humidity sensors, or other type of sensors and transducers may be employed. Sensors may be arranged in any number of configurations and arrangements. Digital on/off as well as analog signaling may be employed by the controller in order to facilitate full automation of fans, pumps, solenoid valves, and compressors which make-up the plant-life support system. Remote video feed and control of agricultural robotics within grow space may also be employed.

The controllers and associated devices may be housed in a modular weatherproof enclosure which may be connected to the 24VDC distribution system. Other non-limiting embodiments may include, without limitation, such arrangements as one where a third party HVAC controller or programmable logic controller (PLC) and third-party grow controllers are combined to provide the essential function of system controller 442 which may allow for a less disruptive integration into existing grow operations. The system controller 442 may communicate with power management controller 202 via a Modbus, LonWorks or BACnet communication protocol, which is a common means of connecting industrial electronic devices.

In one or more non-limiting embodiments, multiple grow pods may be configured wherein one grow pod possesses a control module, and control functions are extended to other grow pods in a master/clone arrangement as illustrated by FIG. 19, wherein digital and analog input and output signal for each plant life-support component is controlled directly and extended throughout a network of grow pods via power sharing connection 394, which may combine DC power and multiple signal channels into a single weatherproof connector, allowing for the omission of controllers in all but the master grow pod, reduction of sensors and control devices, along with more rudimentary versions of primary power modules on the clone grow pods, wherein grow pod operation is able to operate in sequence, while satisfying plant life-support conditions on multiple grow pods.

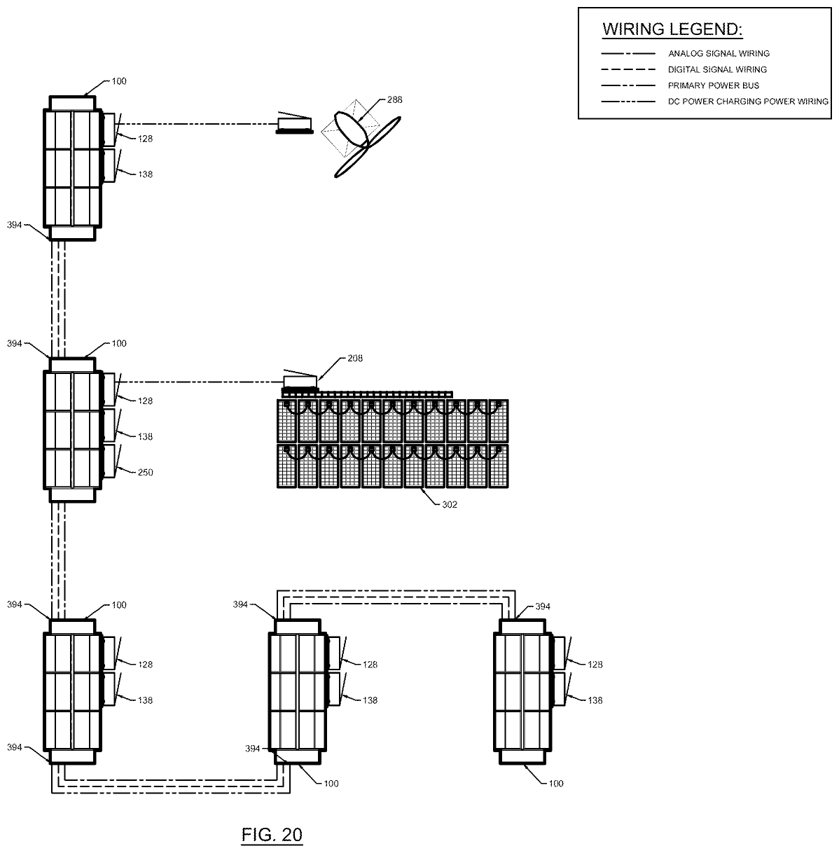

The heating system of the plant life-support system may consist of a hydronic radiant heating system, as illustrated by FIG. 9, 10 and FIG. 14, which heats the grow space and the hydroponic water reservoir during cold weather. In the grow space, radiant tubbing 269 may be looped around DWC buckets 220, wherein heat may radiate directly to the plants and the grow chamber. A hot water pump 272 circulates hot water via hot water piping supply 354 and return 355. Hydroponic nutrient water supply may be indirectly heated via a coiled copper tube bundle 274 located in the hydroponic water reservoir. Heat may be controlled by controlling the water flow via a zone control valve 268. A plate-frame heat exchanger 270 allows for a high temperature primary heating loop, which may be circulated by primary heating pumps 199, and a low temperature secondary radiant heating loop. The source of heat for hydronic heating system may be a solar collector 266 such as that shown on FIG. 20. Thermal storage may be enabled by the use of an integral hot water storage tank 276, which may be used at night when solar heat collection is ‘off’. The source of space heat may be a fuel-fired heating device such as but not limited to a forced-air space heater or infrared heater.

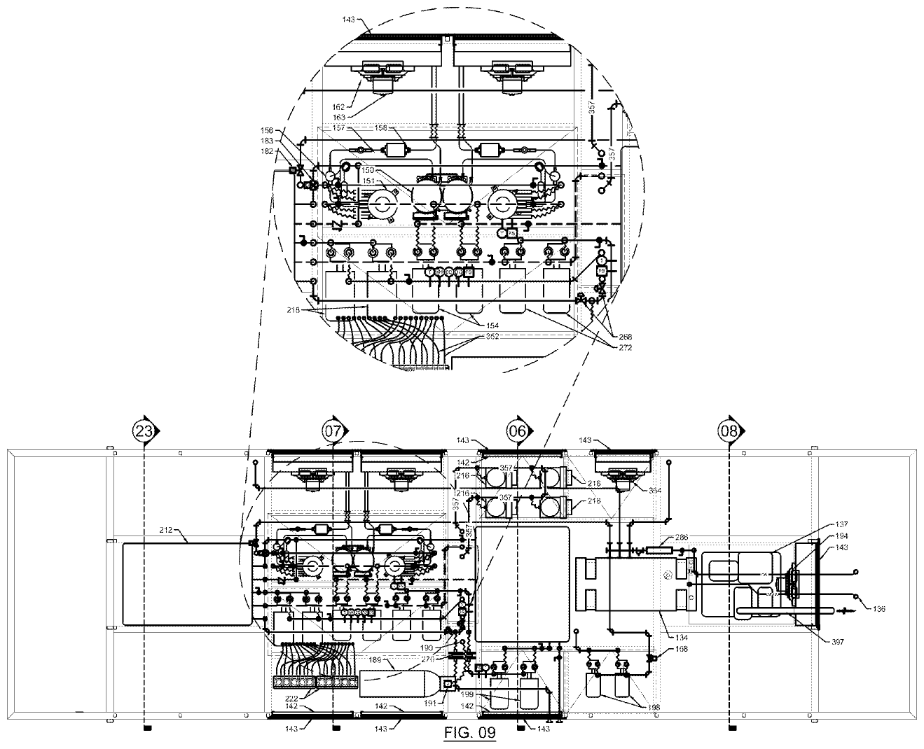

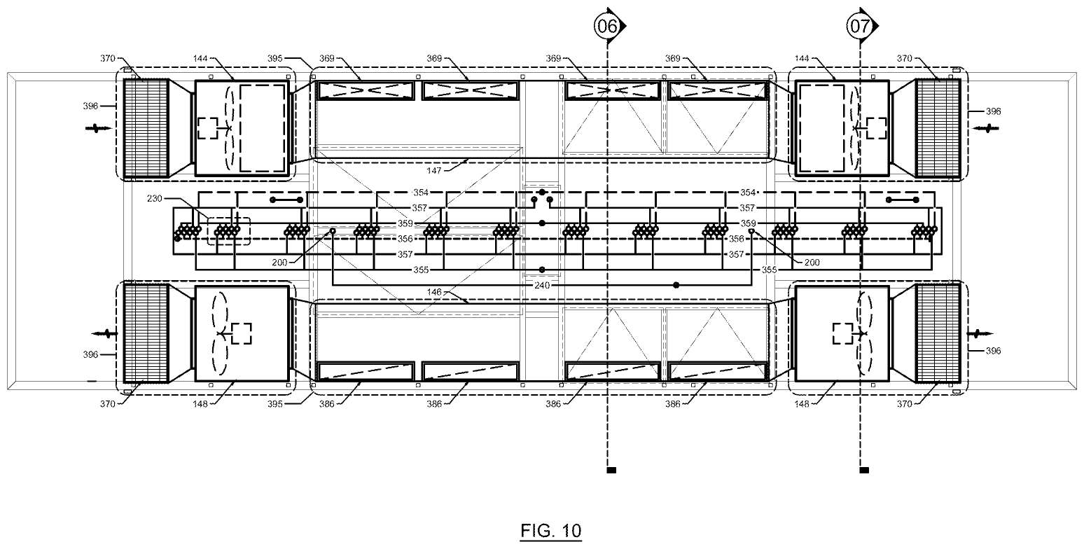

The integral air distribution system of the plant life-support mechanical system may comprise an integral HVAC compartment 396, integral distribution ductwork 395. In one non-limiting embodiment where the climate favors adiabatic cooling systems, an in-line evaporative cooler 144 may be employed in the HVAC compartment 396. The evaporative cooling system is provided to cool the grow space during excessively hot weather. The evaporative cooling system may include: swamp coolers 144 which supply cool air via supply air ducts 147, diffused into plant growing chamber via supply air outlets 369; and exhaust fans 148, which relieve air from grow chamber via exhaust air inlets 386 and into exhaust air ducts 146, which are all located within the grow pod 100, as illustrated in FIG. 10. A light-trap 370 may be also be located in the integral HVAC compartment 396, where crops are sensitive to outside light, or where light deprivation is being employed in on or more non-limiting embodiments.

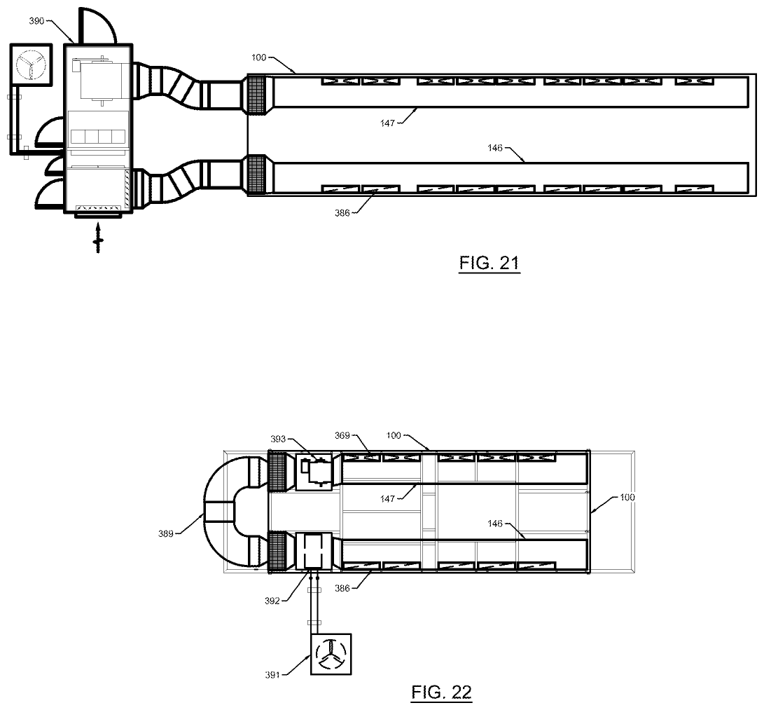

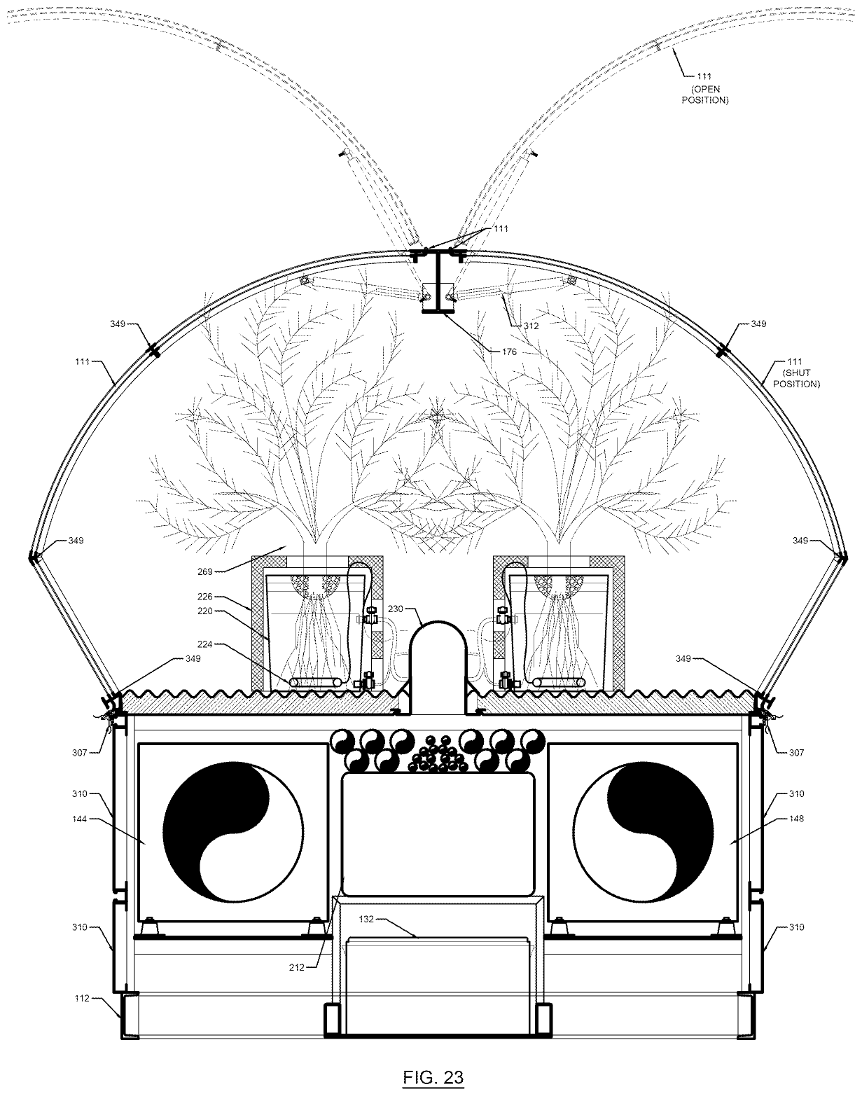

The arrangement of the integral air distribution ductwork 395 and HVAC compartment 396 enables other non-limiting embodiments such as: an arrangement in which external HVAC equipment 390 can be ducted into grow-pod 100 as illustrated by FIG. 21, in climates where the required cooling or heating capacity favors its placement external to the grow-pod 100; an arrangement in which a duct bypass 389 is employed external to grow-pod 100, and a supply fan 393 and DX evaporator coil 392 are split amongst opposite HVAC compartments as illustrated by FIG. 22, where in the condenser resides external to grow pod 100, or in an arrangement similar to the chilled water system condenser 162, wherein air is drawn into the equipment compartment via filtered opening 142 and exhausted via equipment compartment ventilation fan 364, along the side of grow pod 100, such that it does not stray away from the intent of the present invention.

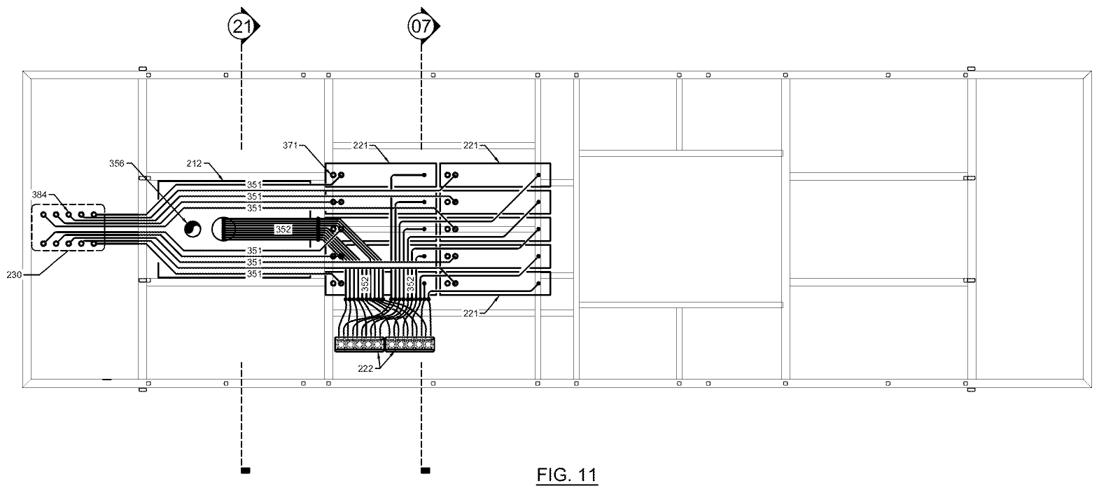

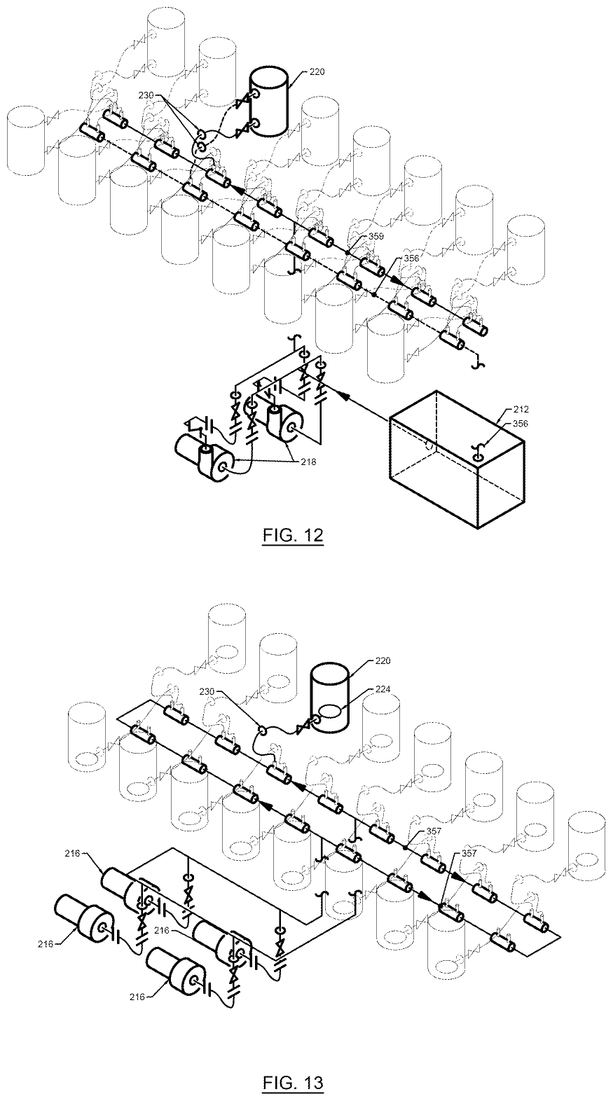

The plant growth system of the plant life-support system, may be fashioned as a deep water culture (DWC) hydroponics method of plant production. In this exemplary non-limiting embodiment, the hydroponic system may be comprised of: a hydroponic circulation system as illustrated on FIG. 12, in which hydroponics pump 218 circulates hydroponics water between a hydroponics reservoir 212 and the plant buckets 220 via supply 356 and return 359 piping; an aeration system as illustrated on FIG. 13, in which blowers 216 supply air thru air piping 357 into DWC plant grow container 220 via a bubbler air pad 224, whereby the blowers may be cycled on or and off by the DDC system based on dissolved oxygen (DO) level measurement of the hydroponics water via the nutrient sensor 223; and a nutrient feed system as illustrated on FIG. 15, in which various nutrient and plant growth solutions such as pH neutralizer and supplements may be filled via a nutrient fill pipe connection 384, at nutrient fill dispenser 219 thru nutrient fill line 351, stored in the nutrient storage tank 221, and pumped into hydroponics reservoir 212 via nutrient dosing pump 222, which is controlled by a nutrient monitor sensor 223. The nutrient sensor 223 may employ the use of electrical conductivity (EC), dissolved oxygen (DO) and pH measurement, along with the use of a pre-programmed schedule, which may be facilitated by the plant life-support control system, allows for the automatic maintenance of nutrient, pH and DO levels, which may vary throughout the life cycle of the crop, by controlling: nutrient dosing pumps 222, which pump from nutrient storage tank 221 into hydroponics reservoir 212 via nutrient tubing 352 and blowers 216. The nutrient storage tank 221 may be vented via tank vent 371 and may include a level float sensor 381 which may be tied-into the DDC system. A plant life-support distribution manifold 230 may run down the center of the grow pod 100, wherein the distribution header distributes air and the hydroponic water supply and return.

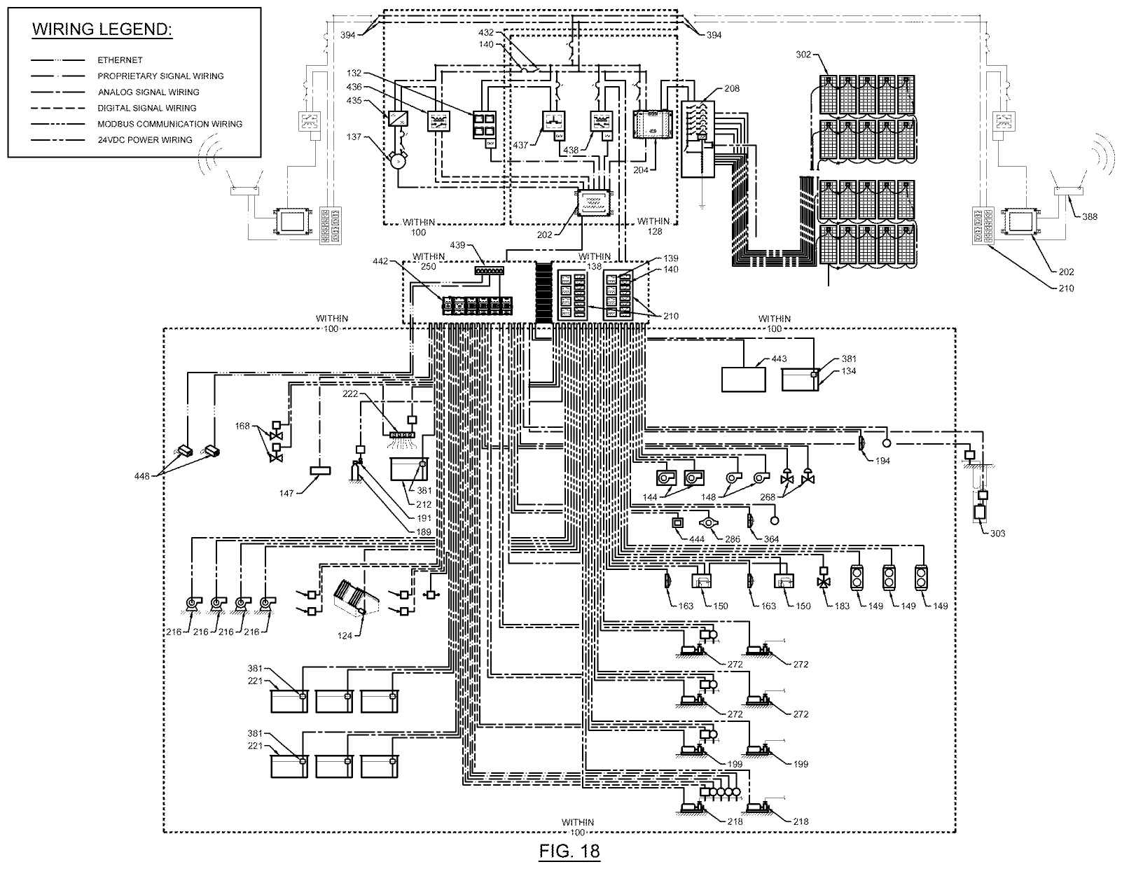

With continued reference to the plant life-support system, the chilled water system controls the hydroponic water temperature. Control of the hydroponic water temperature is critical component of sustained plant growth with the grow pod 100. Temperatures above 72° F. (21° C.) may cause dissolved oxygen (DO) to dip too low. Temperatures below 60° F. (16° C.) may cause plants to slow down their metabolism as the plants “think” the season is changing. The chilled water system, as illustrated in FIG. 17 may be comprised of a water chiller, a chilled water pump 154, a heat exchanger, and any associated piping 155, valves, and control devices among others. The components that make-up the integral water chiller such as the compressor 150, condenser 162, condenser fan 163, refrigerant filter dryer 158, sight-glass 157, refrigerant expansion valve 156 with and evaporator 151 may be housed within grow pod 100 as illustrated on FIG. 9 and FIG. 17. The chilled water pump 154 draws water from the chilled water storage tank 368 via chilled water return piping 353 and pumps it thru the chiller evaporator 151, and then back into the immersion coil 422 via chilled water supply piping 155 within the hydroponic reservoir 212. A 3-way control valve 183 may be employed to divert chilled water either to the immersion coil 422 or to chilled water storage tank 368 enabling thermal storage. The water chiller is cycled on and off based on a call for cooling of the hydroponics reservoir and/or a call for chilled water thermal storage via an immersion temperature sensor by the DDC system. Chilled water system may also include all valves, strainer, and all other necessary accessories to facilitate maintenance.

In one or more non-limiting embodiments, the plant-life support thermal storage system may comprise the elements of said chilled water system, wherein the grow pod is powered by a solar PV system, and chilled water is generated and stored for use at night when power generation is off, thus able to provide chilled water without drawing power.

The CO₂ dosing system of the plant life-support system is provided for optimum growth of the plants within the grow pod 100. CO₂ dosing system may be characterized as a CO₂ enrichment system which is provided to help offset the loss of CO₂ levels within an enclosed system. Plants consume CO₂ during photosynthesis, and the levels within an enclosed environment may be depleted if not replenished. The CO₂ dosing system may be comprised of a CO₂ storage tank 189, a regulator 191, and perforated tubing 190 that distributes the CO2. In this preferred embodiment, the CO₂ tank regulator 191 is cycled open and closed by the DDC system based on a CO2 level measurement via the temperature humidity and CO2 space sensor 447 located in the plant grow chamber. The CO2 tubing is integrated into the grow structure via plant life-support distribution manifold 230 that runs down the center of the pod structure, through which CO2 piping is concealed in and CO2 is dispersed.

The water distribution of the plant life-support system may be comprised of internal water distribution piping 240 which serve make-up water for swamp cooler 144, make-up water for hydronic heating system, a service hose bibb and misting/fogging system. Water consumption by the plant life-support system may be metered and recorded by the DDC system via water meter 286. A misting system booster pump 198 may be employed in order to overcome the pressure loss from the fogging heads 200, which may be controlled by the DDC by opening and closing a solenoid valve 168 based on a call for cooling, via the temperature humidity and CO2 space sensor 447. Water distribution system may also include all valves, strainer, and all other necessary accessories to facilitate maintenance.

Hydronic radiant tubing 269 may be positioned at the edges of the semi-open top of the hydroponic container 220 to transfer heat to the plant and surrounding grow through thermal radiation. DWC plant container insulation 226 may be used to aid in thermal efficiency. Various sizes and shapes of different heat resistant materials may be used for radiant tubing 269 depending on the specific need and service temperature for the plants.

The grow pod 100 may also require infrastructure that is external to the grow pod 100. The required external infrastructure may include and not be limited to a power plant, a heating plant, and a water supply. The power plant may be the primary power source of the grow pod 100. The power plant may be contemplated to provide continuous (during the day) DC power to the grow pod's 24VDC internal distribution system, which powers the grow equipment and charges the batteries integral to the grow pod 100. In one or more non-limiting embodiments the power plant may consist of a photovoltaic (PV) panel array 302, as illustrated in FIGS. 18 and 19. The primary power plant architecture will be fashioned to accommodate the many variations of off grid electricity-producing systems. In one or more non-limiting embodiments, a wind turbine 288 may be added to the power plant as illustrated by FIG. 19, in order to lessen the reliance on the battery energy systems and fuel-fired chargers.

With reference to the required external infrastructure, the heating plant may be the primary source of heat for the grow pod 100. The heating plant may be provided to generate high temperature primary heating water which serves the hydronic radiant heating system in the grow pod 100. The heating plant, in a preferred embodiment, may be comprised of a vacuum tube panel solar water heater and integral insulted water storage tank 266, a circulation pump, and an associated controller. The capacity of the heating plant may vary based on the local climate and geography where the grow pod 100 may be situated.

In another non-limiting embodiment, the heating plant and power plant may be combined via a cogeneration plant, wherein waste heat from power generation in the form of high-temperature heating hot water is distributed to each grow pod, along with power.

Water supply may also be a feature of the required external infrastructure. The water supply may be contemplated as and not limited to a water well 303. Also included may be the associated site distribution piping. Many other variations of a water supply may be accommodated and be included as part of the external infrastructure of the grow pod 100, such as one where rainwater is harvested for use by the water distribution system.

In one or more non-limiting embodiments, control system 250 may have or be connected to one or computing devices. Computing devices may be any type of computing device that typically operate under the control of one or more operating systems, which control various operations of plant life-support system. Computing devices may be a phone, tablet, television, desktop computer, laptop computer, wearable device electronic glasses, networked router, networked switch 439, networked, bridge, or any computing device capable of executing instructions with sufficient processor power and memory capacity to perform operations of control system 250.

Computing device may comprise a housing for containing one or more hardware components that allow access to edit and query control system 250 including control devices, drives, and related control circuitry as well as other components and systems of plant life-support system. Computing device may include one or more input devices such as input devices that provide input to a CPU (processor actions related to user. Input devices may be implemented as a keyboard, a touchscreen, a mouse, via voice activation, wearable input device, a camera a trackball, a microphone, a fingerprint reader, an infrared port, a controller, a remote control, a fax machine, and combinations thereof.

The actions may be initiated by a hardware controller that interprets the signals received from input device and communicates the information to CPU using a communication protocol. CPU may be a single processing unit or multiple processing units in a device or distributed across multiple devices. CPU may be coupled to other hardware devices, such as one or more memory devices with the use of a bus, such as a PCI bus or SCSI bus. CPU may communicate with a hardware controller for devices, such as for a display. Display may be used to display text and graphics. In some examples, display provides graphical and textual visual feedback to a user.

In one or more embodiments, display may include an input device as part of display, such as when input device is a touchscreen or is equipped with an eye direction monitoring system. In some implementations, display is separate from input device. Examples of display include but are not limited to: an LCD display screen, an LED display screen, a projected, holographic, virtual reality display, or augmented reality display (such as a heads-up display device or a head-mounted device), or wearable device electronic glasses. Display may also comprise a touch screen interface operable to detect and receive touch input such as a tap or a swiping gesture. Other I/O devices such as I/O devices may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display may be used as an output device, such as, but not limited to, a computer monitor, a speaker, a television, a smart phone, a fax machine, a printer, or combinations thereof.

CPU may have access to a memory such as memory. Memory may include one or more of various hardware devices for volatile and non-volatile storage and may include both read-only and writable memory. For example, memory may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory may be a non-transitory memory.

Memory may include program memory capable of storing programs and software, including an operating system. Memory may further include an application programing interface (API), and other computerized programs or application programs. Memory may also include data memory that may include database query results, configuration data, settings, user options, user preferences, or other types of data, which may be provided to program memory or any element of computing device.

Computing device may have a transmitter 388, to transmit the received data from the various systems. Transmitter may have a wired or wireless connection and may comprise a multi-band cellular transmitter to connect to the server 120 over 2G/3G/4G cellular networks. Other embodiments may also utilize Near Field Communication (NFC), Bluetooth, or another method to communicate information.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated.

1. A self-contained plant grow pod system, the self-contained plant grow pod system comprised of: a pod structure which serves as a base for a plant growing chamber, the pod structure comprising a structurally self-supported base frame and rigid support frame, and cladding; a rigid self-supported translucent openable top, wherein crops are accessible and wherein sunlight enters the plant growing chamber.

2. The self-contained plant grow pod system of claim 1, further comprising a structure that accommodates piping connection points for various plant-growth systems, as well as a dispersion point for heating and Of cooling air and water for environmental control of the plant growing chamber via an integrated distribution manifold that runs down a center of the pod structure and extends to a grow pod exterior to provide a means of re-filling integral tanks for such things as nutrient water and fuel and a structural arrangement, wherein air discharge and intake for condenser air and ventilation of various equipment compartments, along with a means of forced air ventilation of the grow chamber are integral to the grow pod.

3. The self-contained plant grow pod system of claim 2 further comprising a plant life-support system, the plant life-support system comprising one of systems for plant-growth, including deep-water culture hydroponics, irrigation and CO2 dosing; systems for environmental control of a grow chamber, including a swamp cooler which provides cool air via supply air ducts, water fogging system, hydronic heating system hot water thermal storage, chilled water for hydroponics and chilled water thermal storage; and power systems, and an on-board power-generation and associated fuel system; wherein the power systems include a primary power interface and internal power distribution and direct digital control and monitoring system controllers.

4. The self-contained plant grow pod system of claim 3 wherein the plant life-support system comprises an integrated battery management system positioned in a thermally insulated, temperature controlled compartment of the pod structure wherein the plant life-support system powers electrical loads and charge one or more batteries during normal daytime operation such that the one or more batteries power the electrical loads at night.

5. The self-contained plant grow pod system of claim 1, wherein the translucent openable top is comprised of one or more solar panels and a glazing mullion system connected to a power system.

6. The self-contained plant grow pod system of claim 5, further comprising a backup charger, wherein the backup charger includes a fuel system comprising of piping, a fuel tank reservoir, a pod fuel dispenser, and a generator wherein the backup charger is positioned inside a ventilated enclosure within the pod structure wherein air for combustion is drawn from a louver access door and exhausted by a muffler to an exterior of the pod structure, wherein the fuel system further comprises a fill-limit vent valve, a fuel vent carbon-filter, a fuel supply system which supplies fuel to the generator from the fuel tank reservoir via an anti-siphon valve and a fuel supply line, the fuel tank reservoir having a level float sensor.

7. The self-contained plant grow pod system of claim 1, further comprising a DC BUS connecting a primary power module and a distribution system permitting a network of interconnected self-contained grow pods to form a DC microgrid, wherein a plant life-support system and a control system are configured to provide power and communication sharing between a plurality of self-contained plant grow pod systems.

8. The self-contained plant grow pod system of claim 1, further comprising a hydroponics system wherein the hydroponics system is comprised of a hydroponic circulation pump, a reservoir, a hydroponic container, an aeration system, and nutrient feed system, which comprises a nutrient tank, nutrient feed pump, a water well, and an associated controller, wherein the hydroponic circulation pump circulates hydroponics water between the reservoir and the hydroponic container by supply and return piping.

9. The self-contained plant grow pod system of claim 8, wherein the hydroponics system comprises a water chiller, a chilled water pump, a heat exchanger, wherein the chilled water pump is in fluid communication to a chilled water storage tank and an evaporator and an immersion coil wherein a three way valve is positioned to divert chilled water to the immersion coil or the chilled water storage tank enabling thermal storage.

10. The self-contained plant grow pod system of claim 1 further comprising one or more hydroponic containers, each of the one or more hydroponic containers configured to hold a plant, the one or more hydroponic containers having a base and semi open top configured to allow plant growth, the one or more hydroponic containers having inlets and outlets for access to the one or more hydroponic containers.

11. The self-contained plant grow pod system of claim 3 further comprising an evaporative cooling system wherein an evaporative cooler positioned in a HVAC compartment and a relief fan which work in sequence to circulate air in the grow chamber via supply air and return air ducting which is integrated into the pod structure in order to cool the grow chamber during excessively hot temperatures, wherein a light-trap is positioned in the HVAC compartment.

12. The self-contained plant grow pod system of claim 3 further comprising a heating system which heats a grow space chamber and a hydroponic water reservoir during cold weather, the heating system including a zone control valve, radiant tubing, and associated valves and control devices.

13. The self-contained plant grow pod system of claim 10, wherein radiant tubbing is looped around edges of the semi open top of the one or more hydroponic containers, wherein heat radiate directly to plants in the one or more hydroponic containers, the one or more hydroponic containers having surrounding DWC plant container insulation.

14. The self-contained plant grow pod system of claim 1 further comprising a light deprivation system with a curtain configured to roll the curtain over the pod structure, the light deprivation system comprising a spring-loaded spool with two torsional springs located at ends and within the spring-loaded spool, the spring-loaded spool driven by two arms positioned on opposite side ends of the pod structure wherein the two torsional springs are attached to the two arms opposite of the spring-loaded spool to spread the curtain from a first position at a first end of the pod structure to a second position at an opposite end of the pod structure.

15. The self-contained plant grow pod system of claim 14, the two arms driven by a rotating drive shaft, the rotating drive shaft driven by a right-angle gear drive, wherein a motor is used to drive the right-angle gear drive, wherein the motor is controlled by a direct-digital control system.

16. The self-contained plant grow pod system of claim 15 further comprising latching mechanisms positioned at the opposite side ends of the pod structure wherein the latching mechanisms are configured to secure the spring-loaded spool in position and prevent any movement not initiated by the rotating drive shaft.

17. The self-contained plant grow pod system of claim 1 further wherein a structural member spans a center length of the translucent openable top, the structural member operating as jamb for a dual hinged lid wherein the dual hinged lid rotates with respect to the structural member which remains stationary.
